(19) United States
(12) Patent Application Publication
(10) Pub. No.: US 2008/0286519 A1
(43) Pub. Date: Nov. 20, 2008

(54) MOLDED CEMENTITIOUS ARCHITECTURAL PRODUCTS HAVING A POLISHED STONE-LIKE SURFACE FINISH

(75) Inventors: Dave Nicolson, Lindon, UT (US); Marc J. Stephenson, Cedar Hills, UT (US); Per Just Andersen, Santa Barbara, CA (US); Simon K. Hodson, Santa Barbara, CA (US)

Correspondence Address: Patent Docket Department;Armstrong Teasdale LLP, One Metropolitan Square, Suite 2600, St. Louis, MO, 63102-2740, US

(73) Assignee: E. Khashoggi Industries, LLC, Santa Barbara, CA (US)

(21) Appl. No.: 11/750,838

(22) Filed: May 18, 2007

(51) Int. Cl. B29C 44/20; B32B 27/00; B32B 7/00

(52) U.S. Cl. 428/67; 264/108; 428/220; 428/98

(57) ABSTRACT

A molded cementitious architectural product for use in building construction has a cementitious body made of a molded cementitious material, the surface of which is polished (i.e., burnished) to better resemble natural stone. The polished surface is formed by exposing a portion of the molded cementitious material while in a green condition, more particularly after initial set but before final hardening of the hydraulic cement binder, and burnishing the surface before final hardening. Burnishing the surface of the green cementitious material before final hardening aligns the cement particles at the surface and seals the surface. The inclusion of an organic polymer binder within the cementitious material, such as an acrylic or latex polymer, assists in creating a polished surface resembling natural polished stone. The extent of cement hydration may be determined by monitoring the temperature of the cementitious material within the mold. Hydration may be slowed by quenching the molded green cementitious material with water to extend the window of time within which burnishing may be carried out before reaching final hardening.

### CROSS-REFERENCE TO RELATED APPLICATIONS

None

### BACKGROUND OF THE INVENTION

1. The Field of the Invention

The present invention relates to molded cementitious architectural products having a polished stone-like surface finish as well as methods for manufacturing the cementitious architectural products.

2. The Relevant Technology

Natural cut and carved stone has been used for millennia in constructing buildings, including palaces, temples, monuments and private homes. However, the use of natural cut and carved stone is usually prohibitively expensive for most people. Natural stone may also be too heavy and subject to seismic limitations, depending on the end use. Various products and construction methods have been developed to simulate cut and carved stone on home and building exteriors.

For example, cementitious materials have been used to prepare three-dimensional shapes, which when cured, may serve as window sills, crown moldings, window surrounds, moldings around doors, wall caps, keystones, columns, column caps and bases, and the like. With weight and seismic limitations similar to natural stone, architectural stone products may be produced by casting a cementitious material in a mold to produce decorative and/or structural architectural products. Foam shapes have been covered with a thin layer of cementitious material (e.g., as a shaped stucco), either at a jobsite or at a shop. Light-weight molded cementitious architectural products have also been cast using a polystyrene foam mold, with a portion of the mold remaining as a lightweight foam core that is partially surrounded by a hardened cementitious shell.

The challenge in all of these methods is to yield cementitious products that actually look like natural stone rather than inexpensive cast concrete. In the case of a polystyrene mold, the molded product can have a surface finish that includes the imprint of polystyrene beads. This requires sanding the surface after demolding to remove the polystyrene bead imprints and yield a surface that appears more like natural stone. Because concrete is very hard, the sanding process can be quite difficult once the concrete has been fully hardened. On the other hand, the molded product must remain in the mold long enough for the cementitious material to harden sufficiently to prevent cracking, breakage or surface damage. As a result, the conventional method is to demold the molded cementitious product after the cementitious material has at least passed beyond initial set to ensure sufficient strength to prevent cracking, breakage or surface damage.

Accordingly, there exists a need for improved methods that yield molded cementitious architectural products that have improved surface finish in order to better replicate the look of natural stone. In addition, there exists a need for improved methods that obviate the need to sand fully hardened concrete to remove polystyrene bead indentations in the surface.

### BRIEF SUMMARY OF THE PREFERRED EMBODIMENTS

The present invention relates to the manufacture of molded cementitious architectural products having a polished surface finish that substantially resembles the surface finish of polished natural stone. This is achieved by carefully monitoring the extent of hydration of the hydraulic cement binder within the molded cementitious composition, exposing the surface of at least a portion of the molded cementitious composition while in a partially hydrated condition, and burnishing the exposed surface of the cementitious composition. The act of burnishing the cementitious composition while in a partially hydrated condition aligns the hydraulic cement particles, fills in pores at or just below the surface, and seals the surface without damaging the cementitious composition. The resulting molded cementitious architectural product has a polished surface finish that is very smooth and more closely resembles the surface finish of natural polished stone compared to concrete that is polished (e.g., by grinding or sanding) after substantially complete hydration has occurred.

Material is normally removed during conventional polishing or grinding of hardened concrete. In contrast, the inventive polishing process involves “burnishing” the surface of the partially hydrated cementitious material prior to final hardening, which results in alignment of cement particles without significant removal of material. Moreover, pores in finally hardened concrete cannot be filled in by polishing alone, but requires application of a curable material to fill in the pores. In contrast, burnishing fills in any pores by aligning the cement particles before final hardening.

According to one embodiment, a method for manufacturing molded cementitious architectural products comprises: (1) introducing a wet cementitious composition into a mold having an outer mold body defining an inner mold cavity that at least partially resembles the shape of the final architectural product; (2) causing or allowing the hydraulic cement binder within the cementitious composition to hydrate beyond initial set but before final hardening; (3) before the cement binder has reached final hardening, removing at least a portion of the outer mold body to expose a surface of the cementitious material; (4) burnishing the exposed surface of the cementitious material before the cement binder has reached final hardening; and (5) allowing the cementitious material to continue to hydrate up to and beyond final hardening to yield a final product having sufficient strength for its intended purpose.

The hydration of hydraulic cement is complex and involves many interrelated chemical reactions. Hydraulic cement progresses through various hydration periods over time. Si hydration, or initial hydration, occurs as gypsum precipitates onto calcium silicate silicates and aluminates to control setting; S2 hydration, or induction period, is where hydration slowly progresses; S3 hydration, or acceleration period, corresponds to a period increasing hydration reaction velocity; S4 hydration, or retardation period, corresponds to a period of slower hydration reaction velocity. See http://www.understanding-cement.com/hydration.html.

Another differentiation of hydration is initial set and final hardening, which are defined more fully in the next section. Before reaching initial set, a cementitious composition is flowable and/or plastic and can be shaped or worked as desired without altering the strength of the final hardened material so long as it is properly consolidated. After reaching initial set, the cementitious composition is a form stable solid that is no longer flowable or readily plastically deformable. Nevertheless, after reaching initial set but before final hardening, a cementitious composition can be disrupted and then repaired by reconsolidating the material in the desired shape without permanently damaging the cementitious composition. After final hardening, the cementitious composition cannot be disrupted without permanently weakening or otherwise harming the cementitious composition.

Final hardening does not mean, however, that the cementitious composition has achieved its final strength (which typically does not occur for 28 days), but only that it cannot be disrupted without permanently weakening or otherwise harming the cementitious composition. Thus, “partially hydrated concrete” can refer to cementitious materials that have hydrated beyond final hardening but which have not yet cured sufficiently to achieve 28-day strength. Such materials, if burnished in this state, may be too weak to resist serious surface damage without having the ability to be repaired without causing permanent damage to the cementitious structure.

According to one embodiment, the extent of hydration (or hydration “maturity”) of the hydraulic cement binder can be determined by continuously or periodically measuring the temperature of the molded cementitious composition over time. Cement hydration is an exothermic reaction and results in a rise in temperature of a cementitious composition confined within a mold as hydration progresses. To determine the extent of hydration, the actual temperature of the cementitious material can be compared to the mold. The temperature of the cementitious composition upon reaching initial set will typically be higher than the baseline temperature (e.g., 20° C. initially versus 25° C. upon reaching initial set). The temperature of the cementitious composition upon reaching final hardening will be higher still (e.g., 43-45° C. at final hardening versus 25° C. at initial set).

According to one embodiment, it is desirable to at least partially demold the molded cementitious composition when it reaches a temperature (e.g., 40° C.) that exceeds the temperature of initial set (e.g., 25° C.) but is less than the temperature at final hardening (e.g., 45° C.). In order to maximize the strength of the molded product while still preserving the ability to polish (or burnish) the surface without causing permanent damage, it will generally be desirable to at least partially demold the molded product when the cementitious composition is closer to final hardening than to initial set. For example, it may be preferable to at least partially demold the cementitious composition when it is more than halfway between initial and final hardening as a function of hydration temperature, more preferably when it is more than two-thirds of the way between initial and final hardening as a function of hydration temperature, and most preferably when it is more than three-quarters of the way between initial and final hardening as a function of hydration temperature. In some cases, it may be advantageous to at least partially demold the molded cementitious product just before it reaches final hardening (i.e., when it is about 90-98% of way between initial and final hardening), which may occur at a temperature within about 2-5° C. of the temperature at final hardening.

Although the foregoing embodiment utilizes temperature to determine the extent of hydration, other methods may be used. For example, for a cementitious composition that is known to reach initial set and final hardening within well defined and predicted time intervals, it may be possible to estimate the extent of hydration (i.e., where it is in relation to initial set and final hardening) by simply determining the elapsed time after the cementitious composition was first prepared and/or when it was first placed into the mold cavity.

Once a surface of the molded cementitious product has been exposed by at least partially demolding the product, the surface is advantageously polished (i.e., burnished) before the cementitious composition reaches final hardening. The amount of time that is available for burnishing before the cementitious composition reaches final hardening is largely a function of how soon before final hardening the surface of the molded cementitious product is exposed. In some cases, there may be less than 1 hour, or even less than 30 minutes, to burnish the surface before reaching final hardening, after which further polishing may irreversibly harm (e.g., weaken) any cementitious material that is disrupted by the polishing action.

Notwithstanding the foregoing, the polishing window (i.e., the time before reaching final hardening) can be extended by slowing down the hydration process. This is typically accomplished by quickly cooling the cementitious composition to slow the hydration process. According to one embodiment, hydration of the demolded cementitious composition is slowed by quenching the demolded cementitious part in cool water (e.g., water that is at or below room temperature, or at least substantially below a temperature required to reach final hardening within a predetermined period of time). Quenching the demolded cementitious product before reaching final hardening can increase the burnishing window to more than about 2 hours, preferably more than about 6 hours, and more preferably more than about 12 hours (e.g., up to about 18 hours).

Hydration maturity is dependent on time and temperature and is delayed at lower temperatures. Cooling to lower temperatures generally increases the burnishing window (e.g., cooling to 10° C. can double the burnishing window compared to 20° C.; cooling to 5° C. can increase the burnishing window about 5 times compared to 20° C.).

The exposed surface of the cementitious composition can be burnished using any known polishing or burnishing apparatus. According to one embodiment, the surface of the molded cementitious product is burnished using a Type 27 aluminum oxide polishing wheel attached to a rotary buffing apparatus. The polishing wheel may be rotated at any appropriate speed (e.g., about 4500-6500 RPM) and for any appropriate duration (e.g., about 5-25 seconds) while contacting a portion of the surface being burnished to yield a polished surface having desired surface properties.

The cementitious composition used to form molded cementitious architectural products according to the invention may comprise components known in the art including, but not limited to, hydraulic cement (e.g., Portland cement, white cement and the like), water, one or more aggregates (e.g., fine, medium and/or coarse aggregates), strengthening fibers (e.g., glass fibers, natural fibers, and the like), admixtures (e.g., plasticizers, air entraining agents, water reducers, water binding agents, set accelerators, set retardants, and the like), colorants, texturing components, and the like.

According to one embodiment, one or more polymer binders may be included to further assist in heat burnishing of the surface and alignment of the hydraulic cement particles. Examples of polymer binders that help yield a better polished surface include various latexes, such as acrylic latexes and styrene-butadiene latexes), other acrylic polymers, polyvinyl alcohol, polyvinyl acetate, cellulosic ethers, starches, proteins, polysaccharide gums, rosin, and synthetic resins. Burnishing generates a paste on the concrete surface, which heats up the burnished surface and causes film forming polymers to precipitate and coalesce as a film on the burnished surface as they are heated and water is removed. The polymer film reduces water absorption at the surface, increasing surface strength and freeze thaw resistance.

Certain types of aggregates (i.e., those having platelet shaped particles) may also assist in the burning process to yield a more polished surface. Examples include clay, kaolin, mica and other materials having platelet shaped particles.

Fibers may be added to provide high early strength before final hardening. This permits burnishing the surface of the molded cementitious material while preventing or greatly reducing disruption of the structure at or near the surface. The fibers impart toughness which prevents or greatly reduces cracking. The fibers increase tensile strength, flexural strength and toughness by about 50-200% in all stages of hydration.

The mold used to form molded cementitious architectural products according to the invention may comprise any mold known in the art to produce cast cementitious products. In many cases, the mold cavity will resemble or approximate the shape of the final molded cementitious architectural product. The molded cementitious architectural product may also be machined after demolding to yield a finished product having additional details not represented by the mold cavity. The mold may comprise metal, ceramic, wood, or polymeric material. According to one embodiment, at least a portion of the mold comprises a lightweight polymeric foam material (e.g., polystyrene foam). According to yet another embodiment, a portion of the mold may comprise a polymeric foam core that remains attached to the hardened cementitious composition in order to increase the volume and reduce the overall density of the finished product.

Examples of molded cementitious architectural products that can be manufactured according to the invention include, but are not limited to, columns, caps, bases, balustrades, barrel vaulting, window sills, crown molding, wall caps, keystones, fireplace mantles, column caps and bases, moldings around doors, wall caps, trim stones, quoins, door and window surrounds, countertops, cladding, and the like.

According to one embodiment, molded cementitious architectural products according to the invention may include a foam core and a unitary (i.e., one-piece) shell made of a molded cementitious material that at least partially surrounds the foam core. During the casting process, the cementitious material partially surrounds the foam core and fills the crevices, cavities, and unevenness in the surface of the foam core to affix the shell to the core as the shell hardens. Additional teachings relating to the manufacture of architectural products having a cementitious shell and a foam core are disclosed in U.S. patent application Ser. No. 10/900,969, filed Jul. 28, 2004, and entitled “Molded Stone Architectural Product Having a Foam Core,” the disclosure of which is incorporated by reference.

These and other advantages and features of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a graph which illustrates the heat of hydration of a typical cementitious composition as a function of time;

FIG. 2 is a flow chart which illustrates an exemplary method for polishing a molded green cementitious material;

FIG. 3 is a flow chart which illustrates an exemplary method for monitoring the extent of hydration of a green cementitious material;

FIG. 4 is a graph which illustrates an exemplary hydration curve for a cementitious material that is demolded and quenched prior to reaching final hardening;

FIG. 5A is an exploded perspective view of an exemplary mold for manufacturing a molded cementitious architectural product which includes a front pattern, foam core, backer, and cap;

FIG. 5B is a perspective view of the assembled mold of FIG. 5A;

FIG. 6 is a perspective view of a molded cementitious architectural product formed using, and removed from, the mold of FIGS. 5A and 5B;

FIG. 7 is a perspective view of a molded cementitious architectural product having the appearance of a miter joint;

FIG. 8 is a perspective view of a molded cementitious architectural product suitable for use as crown molding; and

FIG. 9 is a perspective view of a molded cementitious architectural product having a curvature that extends along an arc.

### DETAILED DESCRIPTION OF THE PREFERRED EMBODIMENTS

### I. INTRODUCTION

The present invention relates to molded cementitious architectural products that substantially resemble polished natural stone. The invention achieves this look, at least in part, by carefully selecting the best time interval in which to polish (e.g., burnish) the surface of a molded cementitious material. The optimum time interval has been discovered to be after the hydraulic cement binder has reached initial but before it has reached final hardening. Polishing (e.g., by burnishing) in this time interval allows for alignment of the hydraulic cement particles and sealing of the surface of the cementitious material.

Because the manufacturing process includes introducing a wet cementitious material into a mold, polishing in the optimum time interval typically involves exposing a surface of the partially hydrated cementitious material (e.g., after it has reached initial set). Because burnishing occurs before final hardening, disruptions to the structural matrix caused by the burnishing process do not significantly harm the strength of, or otherwise damage, the cementitious material. The resulting molded cementitious architectural product has a polished surface finish that is very smooth and more closely resembles the surface finish of natural polished stone compared to concrete that is polished (e.g., by sanding or grinding) after complete hydration has occurred.

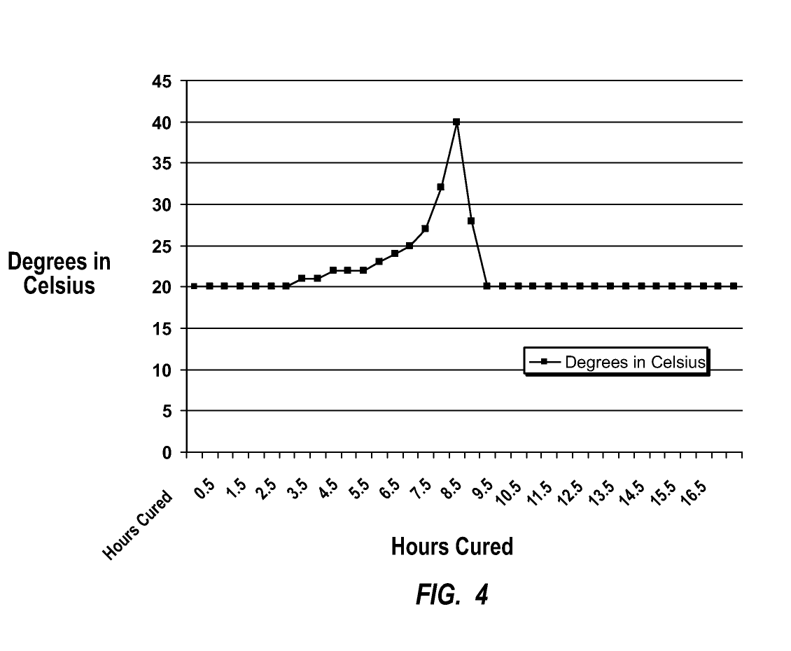

As used herein, the term “initial set” shall refer to the inflection point at which hydration of a molded cementitious material begins to accelerate (e.g., when a temperature of about 25° C. is reached according to examples set forth herein and as illustrated in FIG. 4). This roughly corresponds to the transition between the S2 and S3 hydration periods. The term “initial set” as used herein may not necessarily correlate with the ASTM definition of “time of initial setting” which is the elapsed time after initial contact between the cement and water required for the mortar sieved from the concrete to reach a penetration resistance of 500 psi.

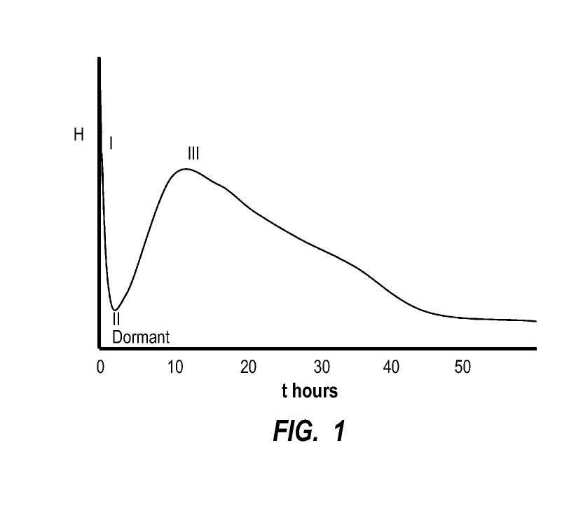

Hydraulic cement progresses through various hydration periods over time. S1 hydration, or initial hydration, occurs as gypsum precipitates onto calcium silicate silicates and aluminates to control setting; S2 hydration, or induction period, is where hydration slowly progresses; S3 hydration, or acceleration period, corresponds to a period increasing hydration reaction velocity; S4 hydration, or retardation period, corresponds to a period of slower hydration reaction velocity. Hydration maturity is dependent on both time and temperature. A description of how to determine hydration maturity is contained in ASTM C1074. A graph showing the heat of hydration as a function of time is illustrated in FIG. 1, which can be found at http://www.understanding-cement.com/hydration.html.

As used herein, the term “final hardening” shall refer to the peak temperature reached during hydration of a cementitious material within a mold (e.g., when a temperature of about 45° C. is reached according to examples set forth herein and which can be derived by extrapolating the curve illustrated in FIG. 4 in view of empirical evidence). This roughly corresponds to the peak of the S3 hydration period (FIG. 1). The term “final hardening” as used herein may not necessarily correlate with the ASTM definition of “time of final setting” which is the elapsed time after initial contact between the cement and water required for the mortar sieved from the concrete to reach a penetration resistance of 4000 psi.

The term “polishing” may mean different things depending on the extent of hydration. In the context of polishing a molded cementitious material prior to final hardening, the term “polishing” means “burnishing”. “Burnishing” means aligning the surface materials, including aligning the cement particles and filling in gaps or pores with cement particles and/or organic polymer and/or fine aggregate particles. After final hardening, even before final curing or 28-day hydration, “polishing” typically involves the removal of material from the surface of the polished substrate.

### II. CEMENTITIOUS COMPOSITIONS

The present invention can be carried using any desired cementitious composition that can be positioned within a mold, allowed to hydrate beyond initial set, at least partially demolded after reaching initial set but before reaching final hardening, burnished in order to yield a polished surface, and allowed to harden to yield an architectural product. Wet cementitious compositions that are placed into a mold will, at a minimum, include at least one type of hydraulic cement binder and water. In general, the cementitious compositions may advantageously include one or types of aggregates and one or more types of organic binders. The cementitious compositions may also include other components as desired, examples of which include strengthening fibers, admixtures, colorants, texturing components, and the like.

Any hydraulic cement material known in the art of concrete manufacture may be used in the manufacture of molded cementitious architectural products according to the invention. Examples of hydraulic cement binders known in the art include Portland cement, cements that fall within ASTM specification C-150-00, white cement, high aluminate cement, high silicate cement, phosphate cement, magnesium oxychloride cement, slag cement, calcium sulfate hemihydrate, ground granulated blast-furnace slag, and hydraulic hydrated lime.

The amount of hydraulic cement within the wet cementitious composition can vary depending on the identities and concentrations of the other components. According to one embodiment, the amount of hydraulic cement is preferably in a range of about 5% to about 90% by weight of the wet cementitious mixture, more preferably in a range of about 10% to about 60% by weight of the wet cementitious mixture, and most preferably in a range of about 15% to about 40% by weight of the wet cementitious mixture.

Water is included within the wet cementitious mixture in order to hydrate the hydraulic cement binder and also provide a desired level of flowability. The amount of water may be selected to provide a predetermined water to cement ratio in order to yield a final hardened cementitious material having a desired strength. In general, reducing the water to cement ratio increases the final strength of the cementitious material. According to one embodiment, the amount of water is preferably in a range of about 5% to about 95% by weight of the wet cementitious mixture, more preferably in a range of about 7% to about 50% by weight of the wet cementitious mixture, and most preferably in a range of about 10% to about 45% by weight of the wet cementitious mixture.

Aggregates may be included in order to decrease cost and yield a final cementitious material having a desired look (e.g., color, texture, and the like). Any aggregate material known in art may be used, examples of which include silica, feldspar, bauxite, calcium carbonate, crushed limestone, crushed granite, other crushed, milled or ground natural stone, crushed, milled or ground glass, crushed, and milled or ground ground ceramic materials. Aggregates of different sizes may be included in order to increase the particle packing density (e.g., two or more of coarse, medium and fine aggregates as are known in the art). Increasing the particle packing density can be beneficial as it generally reduces the amount of water that must be included to yield a wet cementitious composition having a desired level of flowability and/or workability. Reducing the water concentration reduces the water to cement ratio, which generally increases final strength, all things being equal.

Certain types of aggregates, such as those having platelet shaped particles, can further assist in the polishing/burnishing process (e.g., by being aligned alone with the cement particles during the burning process to fill in any pores or discontinuities and thereby yield a smoother, more highly polished surface). Examples of aggregates having platelet shaped particles include, but are not limited to, clay, kaolin, mica, and mixtures thereof.

One of skill in the art can select one or more aggregates in specific amounts and/or ratios to yield wet cementitious materials and/or final hardened cementitious materials having desired properties. According to one embodiment, the total amount of aggregate material is preferably in a range of about 10% to about 90% by weight of the wet cementitious mixture, more preferably in a range of about 20% to about 80% by weight of the wet cementitious mixture, and most preferably in a range of about 30% to about 70% by weight of the wet cementitious mixture.

Strengthening fibers may also be included in order to increase tensile strength, flexural strength, fracture energy and toughness of the final hardened cementitious material. This helps prevent cracking or breakage of the molded cementitious architectural products during use. In addition, the fibers may help develop high early green strength to help reduce formation of cracks or other defects while handling a green cementitious material (e.g., after exposing a surface after initial set, exposing the surface to water to retard hydration, and burnishing the surface while in the green, partially hydrated condition prior to reaching final hardening). The tensile strength, flexural strength and toughness are increased by about 50-200% at all stages of hydration.

Any strengthening fiber known in the art of cementitious materials may be used, examples of which include glass fibers, rock wool, natural organic fibers (e.g., plant fibers), and synthetic organic fibers (e.g., polyester, nylon, polyvinyl alcohol (PVA), polypropylene, and the like). PVA fibers have been shown to be particularly effective at imparting strength the molded cementitious materials. An example of PVA fibers that work well are PVA structural fibers, which are available from Kuraray Specialties Japan. Although fibers of any desired length may be included, included fibers of varying length, the fibers will preferably have a length in a range of about 1 mm to about 25 mm, more preferably in a range of about 2 mm to about 20 mm, and most preferably in a range of about 5 mm to about 15 mm.

In order to maximum the strengthening effect of the fibers and minimize local clumping or fiber build up, which might affect the strength and/or aesthetic qualities of the cementitious material, the fibers are preferably substantially homogeneously dispersed throughout the wet cementitious material. Good fiber dispersion may be accomplished, for example, by means of high shear mixing. In order for the shearing forces to be efficiently transferred from the mixing apparatus down to the fiber level, the wet cementitious composition may include an organic binder or other thickening agent that acts to increase the yield stress and viscosity of the composition. Alternatively, only a portion of the total water may be added initially in order to yield an intermediate composition having increased yield stress and viscosity.

According to one embodiment, the strengthening fibers are preferably included in a range of about 0.001% to about 4% by volume of the wet cementitious mixture, more preferably in a range of about 0.005% to about 2% by volume of the wet cementitious mixture, and most preferably in a range of about 0.01% to about 1% by volume of the wet cementitious mixture.

It has been found that including an organic polymer binder assists in the burnishing process to yield a well polished surface of the cementitious material. Examples of organic polymer binders that have been found to improve burnishing include latexes (e.g., acrylic latexes and styrene-butadiene latexes), other acrylic polymers, polyvinyl alcohol, polyvinyl acetate, cellulosic ethers (e.g., methylhydroxyethylcellulose, hydroxymethyl-ethylcellulose, carboxymethylcellulose, methylcellulose, ethylcellulose, hydroxyethyl-cellulose, hydroxyethylpropylcellulose and hydroxypropylmethylcellulose), starches (e.g., amylopectin, amylose, seagel, starch acetates, starch hydroxy-ethyl ethers, ionic starches, long-chain alkylstarches, dextrins, amine starches, phosphates starches, and dialdehyde starches), proteins (e.g., zein, collagen and casein), polysaccharide gums (e.g., alginic acid, phycocolloids, agar, gum arabic, guar gum, locust bean gum, gum karaya, and gum tragacanth), rosin, and synthetic resins (e.g., polyvinyl pyrrolidone, polyvinylmethyl ether, polyvinyl acrylic acids, polyvinyl acrylic acid salts, polyacrylimides, ethylene oxide polymers, and polylactic acid).

An example of a useful acrylic polymer is AC-100, which is available from Dryvit Systems, Inc., which is located in West Warwick, R.I. An example of a useful latex polymer is VINNAPAS® RE 5028 N, which is available from Wacker Polymers, a company affiliated with Wacker Chemie AG located in Germany. Examples of cellulosic ethers include Methocel®, which is available from Dow Chemical Company, and Tylose®, which is available from SE Tylose GmbH & Co. KG. According to one embodiment, the total amount of organic polymer binder is preferably included in a range of about 0.1% to about 15% by weight of the wet cementitious mixture, more preferably in a range of about 0.2% to about 10% by weight of the wet cementitious mixture, and most preferably in a range of about 0.3% to about 5% by weight of the wet cementitious mixture. The organic polymer binder may alternatively be applied to the surface of the cementitious material prior to or during burnishing to assist the burnishing process.

Fly ash, fumed silica and other pozzolanic materials known in the art may be included in order to affect the strength, cost and performance of the wet and/or hardened cementitious compositions. Admixtures may be used as desired, examples of which include set accelerators, set retardants, plasticizers, air entraining agents, air detraining agents, dispersants, long range water reduces, water binders, and the like.

Although not added to the wet cementitious mixture, various concrete sealants known in the art may be applied to the surface of the wet or hardened cementitious material in order to seal the surface. Examples of useful concrete sealants include fluorosilicates, silicates, and organic polymers. Sealants may be beneficial when utilizing an organic polymer binder that is itself not sufficiently water resistant to help in surface polishing (e.g., cellulosic ethers, which are not as water-resistant as acrylic or latex polymers).

The hardened cementitious compositions should have a strength that will permit the architectural product to perform its intended use. In general, the hardened cementitious compositions will preferably have a 28-day compressive strength in a range of about 1500 psi to about 10,000 psi, more preferably in a range of about 2500 psi to about 9000 psi, and most preferably in a range of about 3000 psi to about 8000 psi.

### III. POLISHING MOLDED GREEN CEMENTITIOUS MATERIALS

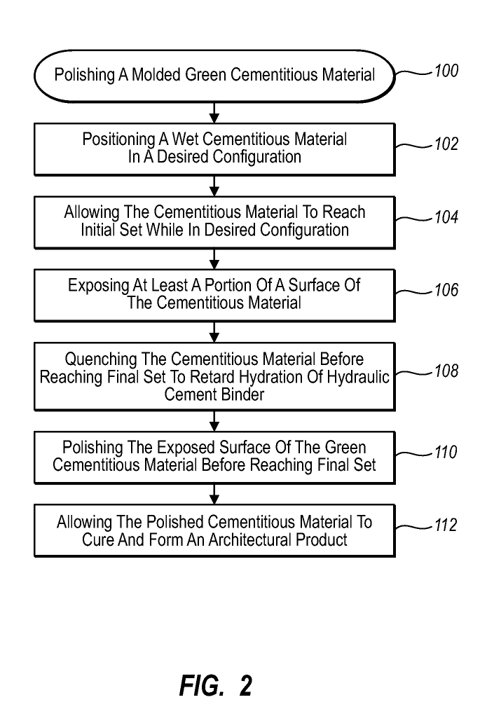

An exemplary method 100 for polishing (i.e., burnishing) a molded green cementitious material is schematically illustrated in FIG. 2. A first act 102 involves positioning a wet cementitious material in a desired configuration. A second act 104 involves allowing the cementitious material to reach initial set while in the desired configuration. A third act 106 involves exposing at least a portion of a surface of the cementitious material. A fourth act 108 involves quenching the cementitious material before it reaches final hardening to retard hydration and increase the window of time before the cementitious material reaches final hardening. A fifth act 110 involves polishing (i.e. burnishing) the exposed surface of the green cementitious material within the window of time before the cementitious material reaches final hardening in order to align hydraulic cement particles and seal the surface of cementitious material. A sixth act 112 involves allowing the polished cementitious material to cure and form a molded cementitious architectural product. The molded cementitious architectural product resulting from act 112 may be used as is or further processes as desired (e.g., by sanding, grinding, polishing, drilling, cutting and the like).

The wet cementitious material may be positioned in a desired configuration using any known molding or shaping process. Examples of molds used to form exemplary molded cementitious architectural products within the scope of the invention are disclosed herein. The present invention is not limited to any particular molding method or molded shape but encompasses a wide variety of different molding methods and molded shapes.

Allowing the cementitious material to reach initial set involves the passage of time. The amount of time that is required for the cementitious material to reach initial set may depend on a variety of factors, including the type and reactivity of the hydraulic cement binder, the water to cement ratio, the inclusion of set accelerators or retardants, the temperature of the cementitious material, and the like. The hydration of hydraulic cement is complex and involves many interrelated chemical reactions. Hydraulic cement progresses through various states of hydration over time. Before reaching initial set, a cementitious material is flowable and/or plastic and can be shaped or worked as desired without altering the strength of the final hardened material so long as it remains properly consolidated. After reaching initial set, the cementitious material is a form Notwithstanding the foregoing, the term “final hardening” does not mean that the cementitious composition has achieved its final strength (which typically does not occur for 28 days), but only that it cannot be disrupted without permanently weakening or otherwise harming the cementitious composition. Thus, “partially hydrated concrete” can refer to cementitious compositions prior to final hardening and also to those which have hydrated (i.e., cured) beyond final hardening but which have not yet achieved 28-day strength.

After reaching initial set but before final hardening, a cementitious material can be disrupted and then repaired by reconsolidating the material in the desired shape without permanently damaging the cementitious material. After final hardening, the cementitious material cannot be disrupted without permanently weakening or otherwise harming the cementitious material. That is true even though hydraulic cement continues to hydrate and develop strength, with a substantial portion of maximum strength being achieved after about 28 days. Thus, there exists a window of time between initial set and final hardening within which a green cementitious material can be polished (i.e., by burnishing) in order to improve the surface properties of the cementitious material without weakening or otherwise harming the cementitious material. After final hardening but before hydrating (or curing) sufficiently to reach a substantial portion of its final strength, a cementitious material may be too weak to resist serious surface damage if polishing or sanding is attempted without the ability to be repaired without causing permanent damage to the cementitious structure.

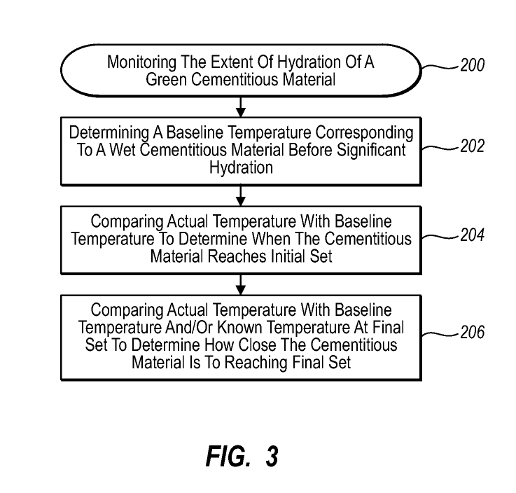

The extent of hydration of the hydraulic cement binder can be determined by continuously or periodically measuring the temperature of the molded cementitious material over time. Cement hydration is an exothermic reaction and results in a rise in temperature of the molded cementitious material as hydration progresses. Accordingly, an exemplary method 200 for monitoring the extent of hydration of a molded green cementitious material is schematically illustrated in FIG. 3, which is based on changes in the temperature of the green cementitious material as hydration progresses.

A first act 202 involves determining or establishing a baseline temperature corresponding to a wet cementitious material before significant hydration of the hydraulic cement binder has occurred. In many cases, the baseline temperature will be the ambient temperature at which the wet cementitious material is initially mixed together (e.g., room temperature, or 20° C.). A second act 204 involves determining when initial set of the hydraulic cement has occurred by comparing the actual temperature of the molded green cementitious material with the baseline temperature. Initial set occurs or is approximated when the temperature of the cementitious material has increased by a predetermined amount above the baseline temperature. By way of example, initial set may occur or be approximated when the temperature of the cementitious material increases 5° C. beyond the baseline temperature (e.g., increases to 25° C. from a baseline temperature of 20° C.).

A third act 206 involves comparing the actual temperature of the cementitious material with the baseline temperature and/or the known temperature at final hardening to determine how close the cementitious material is to reaching final hardening. Final hardening occurs or is approximated when the temperature of the cementitious material has increased by a predetermined amount above the baseline temperature. By way of example, final hardening may occur or be approximated when the temperature of the cementitious material increases 25° C. beyond the baseline temperature (e.g., increases to 45° C. from a baseline temperature of 20° C.) and/or 20° C. above the temperature corresponding to initial set (e.g., increases to 45° C. from an initial set temperature of 25° C.). If it is known that final hardening is achieved when the cementitious material reaches a certain temperature above the baseline temperature, one can determine how close the cementitious material is to final hardening by comparing the actual temperature of the cementitious material with the final hardening temperature. A surface of the cementitious material is advantageously exposed and polished before the cementitious material reaches final hardening.

Reference is now made to FIG. 4, which illustrates an exemplary hydration curve that plots the temperature of a molded cementitious material versus elapsed time from when the cementitious material is first placed into a mold cavity. This hydration curve relates to a process in which hydration of the cement binder is abruptly halted by rapid cooling with water (i.e., “quenching”). During approximately the first three hours (hour 0 to hour 3), the temperature of the cementitious material remains a constant 20° C. During the next four hours (hour 3 to hour 7), the temperature slowly increases 5° C. from 20° C. to 25° C., at which time initial set has been approximately reached. During the next one and one-half hour (hour 7 to hour 8.5), the temperature rapidly increases 15° C. from 25° C. to 40° C., which is close but prior to final hardening.

At this time (hour 8.5), the mold is stripped away from the cementitious material and the cementitious structure is immersed in cool water (e.g., maintained at 20° C. or below). The temperature of the cementitious material then drops rapidly from 40° C. to 20° C. over a period of one hour (hour 8.5 to hour 9.5). After quenching, the temperature of the cementitious material remains constant at 20° C. for at least the next seven hours (hour 9.5 to hour 16.5). Cooling by quenching in water retards the hydration process and delays final hardening to an extent that polishing (i.e., burnishing) may be performed at any time up to about 18 hours after the cementitious product is first immersed in cool water to quench hydration. Hydration can be further slowed by cooling to even lower temperatures (e.g., 10° C., which slows hydration to about half the rate at 20° C., and 5° C., which slow hydration to about one-fifth the rate at 20° C.).

According to one embodiment, it is desirable to at least partially demold the molded cementitious composition when it reaches a temperature that exceeds the temperature of initial set but is less than the temperature at final hardening. In order to maximize the strength of the molded product while still preserving the ability to burnish the surface without causing permanent damage, it will generally be desirable to at least partially demold the molded product when the cementitious composition is closer to final hardening than to initial set. For example, it may be preferable to at least partially demold the cementitious composition when it is more than halfway between initial and final hardening as a function of hydration temperature, more preferably when it is more than two-thirds of the way between initial and final hardening as a function of hydration temperature, and most preferably when it is more than three-quarters of the way between initial and final hardening as a function of hydration temperature. In some cases, it may be advantageous to at least partially demold the molded cementitious product just before it reaches final hardening (i.e., when it is about 90-98% of the way between initial and final hardening). The longer the cementitious material is allowed to hydrate beyond initial set before reaching final hardening, the stronger will be the product and it will better resist premature breakage or damage resulting from demolding prior to reaching final hardening.

It should be understood that the hydration curve depicted in FIG. 4 is based on the particular hydraulic cement binder utilized to generate the curve (i.e., white cement) and does not necessarily apply to all hydraulic cement binders. Other types of hydraulic cement binders, including mixtures of binders, may have their own unique hydration curves (i.e., initial and final hardening may occur at temperatures that differ from those which apply to white cement). Moreover, changing the concentration of hydraulic cement binder may affect the hydration curve. Nevertheless, one of skill in the art will be able to construct a hydration curve based on whatever hydraulic cement binder system is employed in order to monitor the extent of hydration between initial and final hardening. Regardless of the specific binder system employed, it will generally be advantageous to expose a surface of the green cementitious material for burnishing when it has reached a temperature that is within 5° C. of the temperature at final hardening, preferably at temperature that is without about 2-5° C. of the temperature at final hardening.

Although the foregoing example utilizes temperature to determine the extent of hydration, other methods may be used. For example, for a cementitious composition that is known to reach initial set and final hardening within well defined and predicted time intervals, it may be possible to estimate the extent of hydration (i.e., where it is in relation to initial set and final hardening) by simply determining the elapsed time after the cementitious composition was first prepared and/or when it was first placed into the mold cavity.

Once a surface of the molded cementitious product has been exposed by at least partially demolding the product, the surface is advantageously burnished before the cementitious composition reaches final hardening. In the absence of quenching hydration, there may be less than 1 hour, or even less than 30 minutes, to burnish the surface before reaching final hardening, after which further polishing may irreversibly harm (e.g., weaken) any cementitious material that is disrupted by the polishing action. Of course, the burnishing window (i.e., the time after exposing a surface of the cementitious material but before reaching final hardening) can be extended by quenching to slow down the hydration process.

The exposed surface of the cementitious composition can be burnished using any known polishing or burnishing apparatus in order to align the hydraulic cement particles and seal the surface of the cementitious material. In some cases, the burnishing process may be enhanced by including an organic polymer binder within the cementitious material and/or by applying the binder to the surface prior to and/or during polishing/burnishing. According to one embodiment, the surface of the molded cementitious product is burnished using a Type 27 aluminum oxide grinding wheel attached to a rotary buffing apparatus. Other examples of polishing/burnishing pads, wheels or other objects are stone wheels, plastic wheels, fiberglass wheels, and sand paper (e.g., medium to fine grit).

The polishing/burnishing wheel may be rotated at any appropriate speed and for any appropriate duration while contacting a portion of the surface being burnished to yield a polished surface having desired surface properties. The polishing/burnishing wheel is preferably rotated at a speed in a range of about 2500 RPM to about 10,000 RPM, more preferably at a speed in a range of about 3500 RPM to about 8000 RPM, and most preferably at a speed in a range of about 4500 RPM to about 6500 RPM.

The polishing/burnishing wheel preferably contacts each portion of the surface being polished for a time in a range of about 5 seconds to about 25 seconds, more preferably in a range of about 7 seconds to about 20 seconds, and most preferably in a range of about 10 seconds to about 17 seconds.

### IV. MOLDED CEMENTITIOUS ARCHITECTURAL PRODUCTS

The molded cementitious architectural products manufactured according to the invention may have any desired shape or configuration. According to one embodiment, the molded cementitious architectural products may comprise a lightweight foam core that is at least partially surrounded by a cementitious shell. An advantage of including a foam core is that it generally reduces the weight and cost of the molded cementitious architectural products. That is especially true in the case of molded cementitious architectural products which have a relatively thick cross section (e.g., crown molding, fireplace mantles, decorative columns, bases, capstones, and the like).

According to another embodiment, the molded cementitious architectural products may comprise a monolithic cementitious structure that does not include a foam core. One example where it may be desirable or advantageous to omit the foam core is in the case of trim or molding of relatively thin cross section. Providing a monolithic cementitious structure generally results in a product of increased strength and durability. Another example where it may be desirable or advantageous to omit the foam core is in the case of structural products, such as columns, beams, bases, foundation stones or other structures that are required to bear a substantial load and/or will be subjected to high stresses. In yet another example, the cementitious material may form a unitary shell that at least partially surrounds a hollow interior portion rather than a foam core. The hollow interior portion may remain hollow or it may be filled with another material during use (e.g., mortar to adhere the cementitious product to a wall or other stationary structure, stucco to yield a product having multiple surface finishes, strips of wood or other decorative material, small mosaic tiles, and the like).

In general, the inventive polishing/burnishing methods may be used to increase the beauty and improve the surface finish of virtually any molded cementitious architectural product, whether molded according to the exemplary procedures disclosed herein or other molding processes known in the art or that may be developed. The only requirement is to provide an exposed surface of the green cementitious material after initial set and before final hardening, which is then burnished in order to better align the hydraulic cement particles and/or seal the surface of the cementitious material.

According to one embodiment, the mold apparatus may include two or more mold parts that are positioned relative to each other so as to at least partially define a mold cavity therebetween having a desired shape of a molded cementitious structure. In some embodiments, at least one of the mold parts remains permanently attached to the hardened cementitious structure (e.g., in the foam of a foam core that is at last partially surrounded by the cementitious shell). In other embodiments, the mold parts may be entirely removed from the molded cementitious product. At least one of the mold parts has a shape that at least partially corresponds to a desired shape of the molded cementitious product (e.g., an outer exposed surface that will be polished according to the invention). Such a mold part may be referred to as a “front pattern”.

In the case where a front pattern and foam core are positioned in a spaced apart configuration to provide a mold cavity therebetween into which cementitious material is to be introduced, the front pattern and foam core must typically be held in place by another mold part to prevent separation and/or collapse. Such a mold part may be referred to as a “backer”.

The foam core, when used, may be made of any type of foamed polymer that has sufficient strength to support the molded cementitious shell. Foam is any material containing a solid structural portion and a distributed mass of gas bubbles dispersed throughout the solid structural portion. The foam core may be made of a variety of foamed polymer materials including, but not limited to, expanded polystyrene, polyurethane, polyethylene, polypropylene, polyester, polyvinyl chloride, polyacrylonitrile, ABS, polyamide, polyoxymethylene, polycarbonate, rubber, phenolic, polyimide, acrylic, flouropolymer, epoxy, or silicone polymers. The foamed polymer core should be capable of being shaped in a three dimensional form through molding, machining, extrusion, or any other generally known method in the art.

Expanded polystyrene (“EPS”) is an excellent foam core material because of its ease of processing, relatively low density, and relatively high strength. EPS is a generic term for polystyrene and styrene copolymers that are shaped, expanded, and molded into foam shapes. EPS may be purchased in large blocks having a desired density. In some applications, a density of about 0.8 lb/ft³ to about 3 lbs/ft³ may be desirable. In other applications, a density of about 1 lbs/ft³ to about 2 lbs/fl³ may be desired. EPS may also be easily shaped by a computer-assisted foam-cutting machine that uses a hot wire to cut the EPS block into the desired three dimensional shapes.

The front pattern may comprise any desired material, include foam or non-foam materials. The front pattern may be made from any metal, wood, plastic, ceramic, composite, or material that is able to give the cementitious slurry a desired shape while the cementitious slurry cures. According to one embodiment, it is formed by cutting an EPS foam block with a hot wire or computer-assisted foam-cutting machine that has been pre-programmed with the desired shape of the front pattern. The front pattern may alternatively be obtained by thermoforming a plastic sheet over a model or using standard machining practices to obtain the desired shape of the front pattern. In other embodiments, the front pattern may be formed by molding, machining, or extrusion.

The foam core may similarly be made by cutting with a hot wire. The foam core may be cut from the same block as the front pattern during the same cutting operation.

The front pattern and/or foam core may be attached to a backer when forming the mold cavity. The backer can form part of the mold and help encapsulate and define a portion of the mold cavity. The backer helps to prevent the cementitious slurry from flowing out of the mold and maintains the foam core and front pattern in a desired spaced apart configuration. The foam core and/or front backer may be affixed to the backer by mechanical fasteners that include, but are not limited to, tape, cord, nails, screws, nuts and bolts, straps, clamps, and various other types of fasteners. The foam core may also be affixed to the backer by adhesives including hot glue (polyethylene) or other types of adhesives that do not dissolve the foam core. Alternatively, the front pattern may be affixed to the backer by abutting other molds or heavy objects against the front pattern and/or backer.

Before the backer and front pattern are affixed together, the backer and front pattern may be covered with a mold release. The mold release may include any known mold release known in the art. For example, vegetable oil may be used as a mold release.

The front pattern is preferably shaped and disposed relative to the foam core or other mold part to create a mold cavity that is at least about ¼ inch in cross-section/width. In applications where a foam core is used and/or where the cementitious product at least partially surrounds a hollow portion, the width of the mold cavity may advantageously range from about ¼ inch to about 1 inch. In some configurations, the mold cavity may have a width that is about ⅛ of an inch or it may be greater than 1 inch as desired. The width of the cavity generally determines the thickness of the molded cementitious material.

The foam core may include a three dimensional surface configuration that is similar to the surface of the front pattern. When this is done, the cementitious shell of the architectural product may have a substantially uniform thickness. Controlling the shell thickness may allow a minimum amount of cementitious material to be used while reducing or eliminating localized areas of weakness strength.

Once a mold is formed, a cementitious slurry is introduced into the mold cavity. An area of the mold is typically left open to provide a conduit for the cementitious material to enter and fill the mold. The mold cavity may be sealed by means of one or more caps or plugs that close one or more areas of the mold that are not enclosed by the front pattern and backer. During and/or after introducing the cementitious composition in the mold, the mold may be vibrated to help remove air bubbles greater than 1 mm and consolidate the wet cementitious composition. The cementitious material is then allowed to partially cure within the mold cavity.

According to one embodiment, a method for manufacturing a molded cementitious architectural product for use in building construction includes: (1) obtaining a front pattern having a desired surface configuration for the molded cementitious architectural product; (2) obtaining a foam core; (3) affixing the foam core to a backer; (4) affixing the front pattern to the backer in a desired spaced apart orientation relative to the foam core to define a mold cavity between the front patter, foam core and backer; (5) introducing a cementitious material into the mold cavity and into contact with the foam core and other mold parts; (6) allowing the cementitious material to partially hydrate to at least initial set but before final hardening; (7) exposing a surface of the molded cementitious material before reaching final hardening to permit burnishing thereof; (8) burnishing the exposed surface of the cementitious material; and (9) allowing the cementitious material to continue hydrating up to and beyond final hardening (typically a period of time within which the cementitious material has achieved sufficient strength to be used for its intended purpose without breakage, cracking or formation of other defects that occur when the cementitious material is not sufficiently hardened).

Molded cementitious architectural products according to the invention may have a shell with an average thickness that may be greater than or equal to about ¼ of an inch. The shell may also have an average thickness from about ¼ inch to about 1 inch or greater. In other configurations the thickness of the shell may be about ⅛ of an inch or greater than 1 inch. Structural products with or without a foam core can have greater thicknesses as required. The architectural cast stone product according to the invention may be made in any shape including, but not limited to, linear, geometric, curved forms, and ornate three dimensional shapes.

In order to provide specific examples of molding processes, mold shapes and mold materials that may be used to manufacture molded cementitious architectural products according to the invention, reference is now made to the drawings. It should be understood that the molding processes, mold configurations and mold materials disclosed herein are merely given by way of example, not limitation. In addition, reference is made to U.S. application Ser. No. 10/900,969, filed Jul. 28, 2004 and entitled “Molded Stone Architectural Product Having a Foam Core”. For purposes of disclosing the manufacture of molded architectural stone products that include a foam core and a cementitious shell, the foregoing application is incorporated by reference.

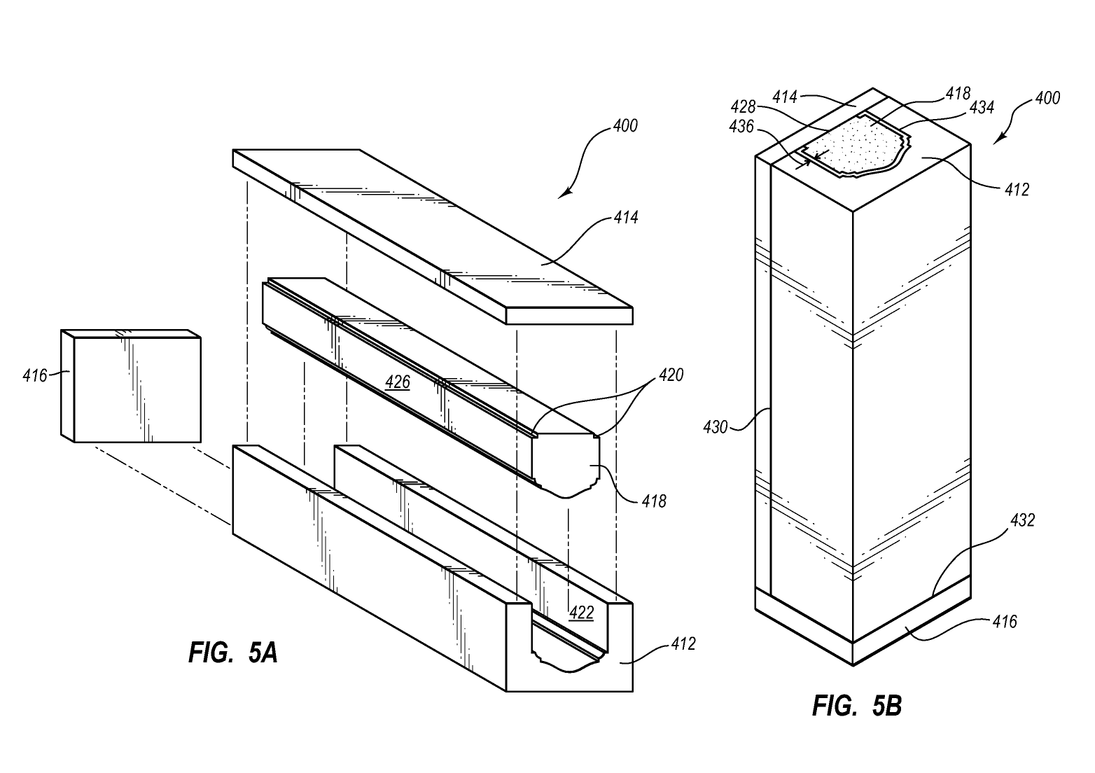

FIGS. 5A and 5B illustrate a mold 400 for producing a molded cementitious architectural product. FIG. 5A depicts the mold 400 in exploded form prior to assembly. FIG. 5B depicts the mold 400 in assembled form. The mold 400 includes a front pattern 412, backer 414, cap 416 and foam core 418 positioned within an interior space of front pattern 412. The front pattern 412 and the foam core 418 may be cut for efficiency from a single block of EPS or other material. The foam core 418 may include one or more recesses 420 formed in the foam core 418 to provide a mold cavity that also defines wraparound extensions of a shell formed from a cementitious material. The wraparound extensions help to grip the foam core 418 and affix the cementitious material to the foam core of the architectural product. The cap 416 may optionally be integrally formed with either the front pattern 412 or the backer 414.

The exposed internal surfaces 422 of front pattern 412 may be coated with a mold release for easier removal of the front pattern 412 from the molded cementitious architectural product (e.g., while in a green condition). A variety of mold release materials known in the art may be used, including but not limited to silicon, Teflon (tetrafluoropolyethylene), natural oil, synthetic oil or wax. An example of a natural oil is ordinary non-stick cooking spray.

The foam core 418 is advantageously not coated with a mold release because it is generally desirable for the foam core 418 to adhere to the molded cementitious material. Typically, the cementitious composition will adhere and bond to the irregularities of the foam core and remain affixed to the foam core when fully cured without requiring a bonding agent. Of course, all surfaces to which the cementitious material is intended to adhere should be clean and free of oil, grease, dirt, decomposed foam or anything that might inhibit adhesion of the cementitious material to the foam. The exposed external surface 426 of the foam core 418 may optionally be coated with bonding agents known in the art to promote adhesion of the cementitious material to foam core 418.

To form the assemble mold 400 shown in FIG. 5B, adjoining surfaces of the various mold parts may be affixed together using an adhesive, mechanical affixing means, other molds positions next to and/or stacked on top of the mold, and the like. These include an adjoining surface 428 between the foam core 418 and backer 414, an adjoining surface 430 between the front pattern 412 and backer 414, and an adjoining surface 432 between the cap 416 and the front pattern 412 and backer 414. If an adhesive is used, the amount of adhesive may advantageously be enough to affix the mold parts together, but not so much that it is later difficult to separate the mold parts and the backer 414 can be removed from the foam core 418 without damaging the foam core 418. Other affixing means may include, but are not limited to, tape, clamps, screws, bolts, or even other molds positioned adjacent to mold 400.

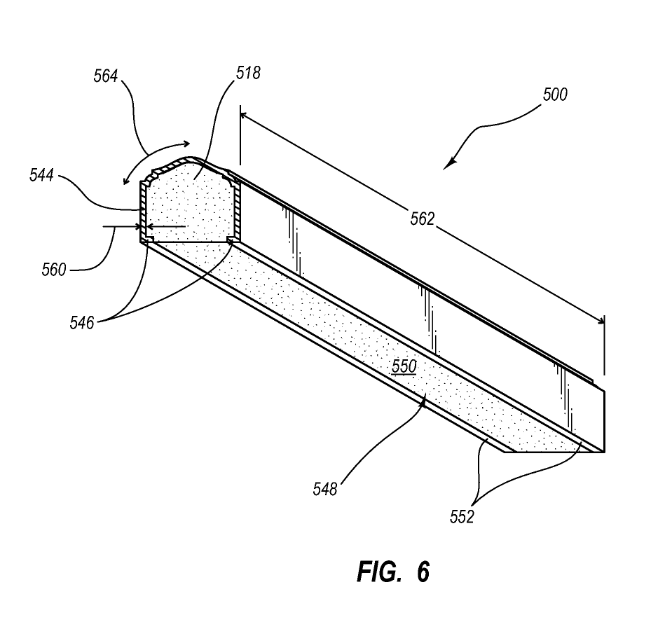

The assembled mold 400 shown in FIG. 5B defines a mold cavity 434 having a desired shape a cementitious shell to be formed around the foam core 418 (FIG. 6). The mold cavity 434 generally has a desired cavity width 436 that corresponds to a desired thickness of the molded cementitious shell. According to one embodiment, he mold cavity 34 may have a cavity width 36 in the range from about one quarter inch to about one inch, which will result in an equivalent thickness of a cementitious shell around the foam core 418. Of course, the width 436 of mold cavity 434 can be varied from about one eighth of an inch to beyond one inch according circumstances and need. If the mold cavity 434 has a greater cavity width 436, the cementitious material can be more viscous and may contain larger sized aggregate materials compared to when cavity width 436 is smaller.

Once the mold 400 is assembled, the mold cavity 434 is filled with cementitious material. When the cementitious material is introduced into mold cavity 434 (e.g., by pouring), the mold 400 may be vibrated to help the cementitious material flow into all parts of the mold cavity 434 and remove air bubbles greater than 1 mm in diameter. The mold 400, once filled, is set aside to allow the cementitious material to partially hydrate and form a green cementitious material. After initial set but before final hardening, one, some or all of the front backer 412, backer 414 and cap 416 can be removed to expose a surface of the green cementitious material to permit burnishing thereof (e.g., after quenching with cool water to slow the rate of hydration and extend the operational window within which polishing can occur without harming the strength or other properties of the cementitious material).

FIG. 6 shows a perspective view of a molded cementitious architectural product 500 formed using mold 400 described herein. As shown, the molded cementitious architectural product 500 includes a unitary cementitious shell 544 and a foam core 518. The cementitious shell 544 is integrally formed around the foam core 518. The cementitious shell 544 in this example includes wraparound extensions 546 that help affix the foam core 518 to the shell 544. The wraparound extensions 546 also provide the molded cementitious architectural product 500 with increased structural and mechanical strength and stability without the need for the cementitious shell 544 to fully enclose the foam core 518.

The molded cementitious architectural product 500 also includes a mounting surface comprised of an exposed surface 550 of the foam core 518 and adjacent surfaces of the cementitious shell 544. The adjacent surfaces of the cementitious shell 544 include the exposed side of wraparound extensions 546.

The cementitious shell 544 of this embodiment is defined by multiple dimensions: shell thickness 560, length 562 and various three dimensional aspects 564 (e.g., shell width, depth, curvature, angles, and the like). The thickness 560 of cementitious shell 544 may be greater than about one fourth of an inch. Typically, the thickness 560 of the cementitious shell 544 is from about one fourth inch to about one inch. The thickness 560 of the shell 544 may be continuous or it may vary along the length 562 and/or through the various three dimensional aspects 564.

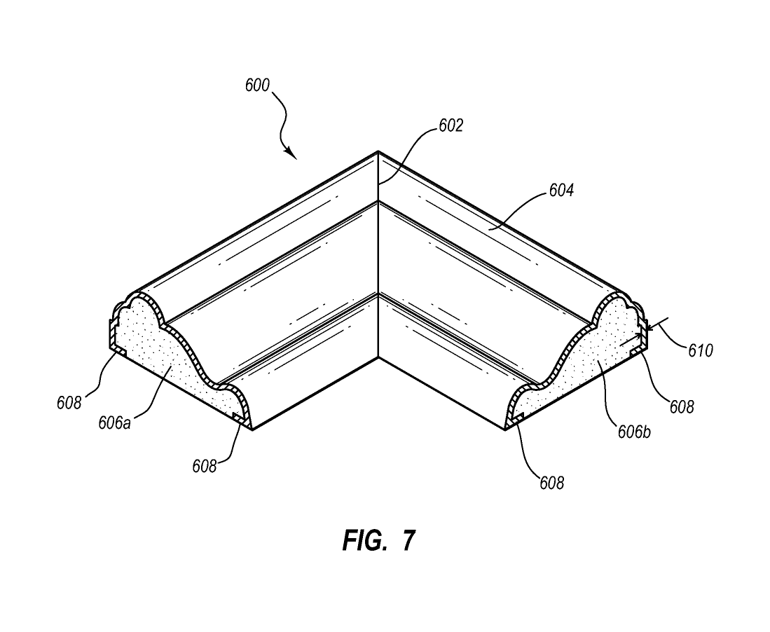

FIG. 7 illustrates a molded cementitious architectural product 600 that includes an integrally formed miter joint 602. As shown, the molded cementitious architectural product 600 includes a unitary cementitious shell 604 affixed to a foam core 606 comprised of first and second parts 606a and 606b. The cementitious shell 604 also includes wraparound portions 608. The shell 604 of this example has a substantially uniform thickness 610, preferably greater than about one fourth of an inch. The thickness 610 may range from about fourth inch to about one inch or be as thin as about one eighth of an inch.

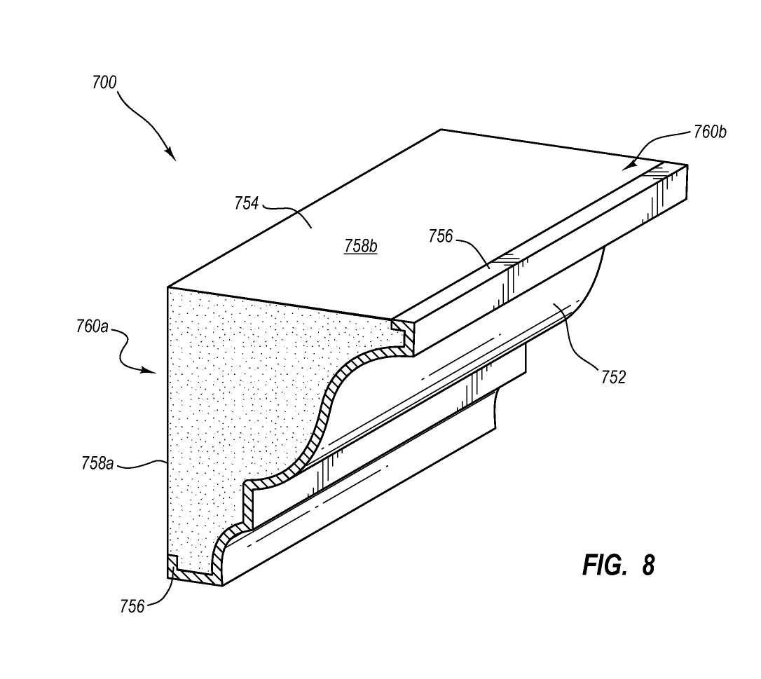

FIG. 8 illustrates another example of a molded cementitious architectural product 700, which includes a cementitious shell 752 that partially surrounds a foam core 754. The shell 752 includes wraparound portions 756 that are substantially flush with exposed surfaces 758 of the foam core 754. The positioning of the wraparound portions 756 allows the cementitious shell 752 to reliably grip and hold the foam core 754 with a minimum amount of material.

The exposed surfaces 758 of the foam core 754 include individual surfaces 758a and 758b that are perpendicular to each other. The exposed surfaces 758 and wraparound portions 756 form mounting surfaces 760a and 760b which are perpendicular to each other. The architectural product 700 can be used as crown molding, where its light weight is an advantage over solid cut or cast stone products, with the mounting surfaces 760 being available for mounting to a ceiling or eave and an adjacent perpendicular wall. Mounting can be achieved using adhesives and/or mechanical fasteners.

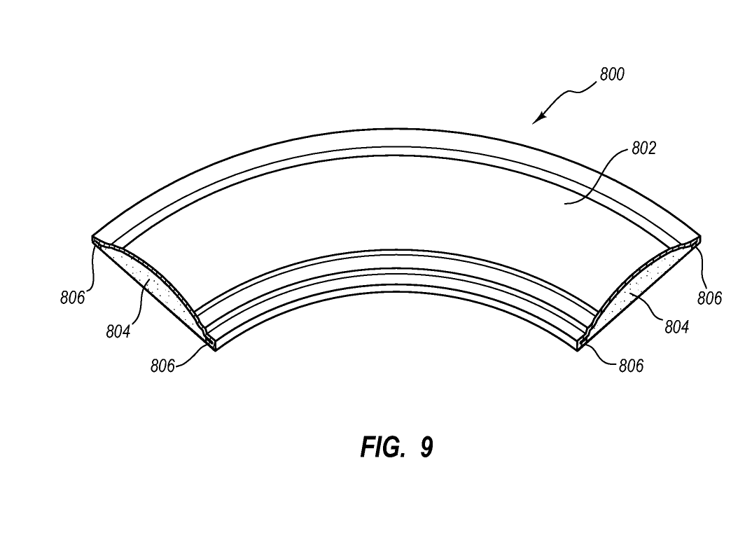

FIG. 9 illustrates another configuration of a molded cementitious architectural product 800 that is curved. The molded cementitious architectural product 800 includes a cementitious shell 802 that partially surrounds a foam core 804. This configuration also includes wraparound portions 806. The architectural product 800 may be used as a trim piece or casing for a curved window or door.

It should be understood that including a foam core is not necessary, or even desirable, in all cases. The architectural product may comprise a monolithic cementitious body with no foam core as desired or required by a specific product. Any of the architectural products depicted in the drawings can be modified by omitting the foam core entirely or reducing the size of the foam core to increase the thickness of the cementitious shell. Other shapes of architectural products are certainly within the scope of the invention, including but not limited to cross sections that are square, rectangular, triangular, polygonal, circular, elliptical, and the like.

### V. EXAMPLES

The following examples are provided to help illustrate how to manufacture molded cementitious architectural products according to the invention. These examples are to be understood as being merely exemplary and not limiting.

### Example 1

A wet cementitious mixture was prepared for use in manufacturing molded cementitious architectural products by mixing together the following components in the stated amounts (% means weight percent unless otherwise specified):

| | | |
|---|---|---|
| Water | 8.5 lb | 14.3% |
| Lehigh White Cement | 15 lb | 25.2% |
| Marble Mix | 21 lb | 35.3% |
| Specialty Minerals #9 Limestone | 9 lb | 15.1% |
| Uniman Sand (90 grit) | 4 lb | 6.7% |
| AC-100 Acrylic Polymer | 1 lb | 1.7% |
| Wacker RE 5028 N Latex Polymer | 1 lb | 1.7% |
| PVA Fibers (20 g) | 0.04 lb | 0.07% |

| | |
|---|---|
| Color | variable as specified |

A portion of the water (30%) was initially blended with the aggregates (i.e., marble mix, limestone and sand) and the latex polymer within the mixing drum of a standard concrete mixer. After 15 seconds the color and fibers were added to the mixture, which was allowed to mix for a total of 3 minutes. Following the initial mixing sequence the mixing drum was scraped. Thereafter, the remaining water and the white cement were added proportionally to the mixing drum, followed by mixing for an additional 3 minutes, followed by another scraping of the mixing drum. The acrylic polymer was then added to the mixing drum, followed by mixing for an additional 1 minute, followed by additional scraping. Finally, the mixture was mixed for an additional 2 minutes to yield the wet cementitious material.

The wet cementitious material was used to manufacture various molded cementitious architectural products, including products similar to those illustrated in FIGS. 5-8. After reaching initial set but before final hardening, a portion of the green cementitious material was exposed and burnished using a Type 27 aluminum oxide polishing/burnishing wheel attached to a rotary buffing apparatus. Thereafter, the green cementitious material was allowed to hydrate beyond final hardening to yield a final hardened molded cementitious architectural product having a polished surface that more closely resembled authentic polished stone compared to a molded cementitious product that was sanded or polished after complete hardening of the cementitious material.

### Example 2

A wet cementitious mixture was prepared for use in manufacturing molded cementitious architectural products by mixing together the following components in the stated amounts (% means weight percent unless otherwise specified):

| | | |
|---|---|---|
| Arcustone ® Pre-bagged Concrete | 50 lb | 85.1% |
| (exact contents unknown) | | |
| Water | 7.75 lb | 13.2% |
| AC-100 Acrylic Polymer | 1 lb | 1.7% |

A portion of the water (70%) was initially blended with the Arcustone, followed by the remainder (30%) of the water within the mixing drum of a standard concrete mixer for 3 minutes. Following the initial mixing sequence the mixing drum was scraped. Thereafter, the acrylic polymer was added to the mixing drum, followed by mixing for an additional 3 minutes to yield the wet cementitious material.

The wet cementitious material was used to manufacture various molded cementitious architectural products, including products similar to those illustrated in FIGS. 5-8. After reaching initial set but before final hardening, a portion of the green cementitious material was exposed and burnished using a Type 27 aluminum oxide polishing/burnishing wheel attached to a rotary buffing apparatus. Thereafter, the green cementitious material was allowed to hydrate beyond final hardening to yield a final hardened molded cementitious architectural product having a polished surface that more closely resembled authentic polished stone compared to a molded cementitious product that was sanded or polished after complete hardening of the cementitious material.

### Example 3

A wet cementitious mixture was prepared for use in manufacturing molded cementitious architectural products by mixing together the following components in the stated amounts (% means weight percent unless otherwise specified):

| | | |
|---|---|---|
| Water | 12.5 lb | 15.0% |
| White Cement | 30 lb | 36.1% |
| Marble Mix | 21 lb | 25.3% |
| Specialty Minerals #9 Limestone | 9 lb | 10.8% |
| Wacker RE 5028 N Latex Polymer | 1 lb | 1.2% |
| Sand (#60 420) | 8 lb | 9.6% |
| PVA Fibers (80 g) | 0.18 lb | 0.022% |
| Glenium (water reducer) (57 g) | 0.13 lb | 0.016% |
| Methocel (2 g) | 0 lb | 0% |
| Color (600 g) | 1.32 lb | 1.6% |

All the dry ingredients were placed in the mixing drum of a standard concrete mixer and mixed for 1 minute. A portion of the water (38%) was added to the mixing drum followed by mixing for 5 minutes. The remainder of the water and the Glenium were added and then mixed for 3 additional minute to yield the wet cementitious material.

The wet cementitious material was used to manufacture various molded cementitious architectural products, including products similar to those illustrated in FIGS. 5-8. After reaching initial set but before final hardening, a portion of the green cementitious material was exposed and burnished using a Type 27 aluminum oxide polishing/burnishing wheel attached to a rotary buffing apparatus. Thereafter, the green cementitious material was allowed to hydrate beyond final hardening to yield a final hardened molded cementitious architectural product having a polished surface that more closely resembled authentic polished stone compared to a molded cementitious product that was sanded or polished after complete hardening of the cementitious material.

Although the examples which follow are hypothetical in nature, they are based up and/or extrapolations from pre-existing cementitious mix designs developed by one or more of the inventors. They are illustrative of cementitious composition that may be used to manufacture molded cementitious architectural products. Increases in the cement paste fraction typically increase workability, while increases in the water-to-cement ratio typically increase workability but decrease strength.

### Example 4

A wet cementitious mixture having a water to cement ratio of 0.35 is prepared for use in manufacturing molded cementitious architectural products by mixing together the following components in the stated amounts (% means weight percent unless otherwise specified):

| | | |
|---|---|---|
| Water | 5.25 lb | 8.77% |
| Methocel | 0.018 lb | 0.03% |
| French Cream #33 (66 g) | 0.15 lb | 0.24% |
| PVA Fiber (77 g) | 0.17 lb | 0.28% |
| Viscocrete 2100 (H₂O reducer, 136 g) | 0.3 lb | 0.50% |
| White Cement | 15 lb | 25.05% |
| Marble Mix | 21 lb | 35.07% |
| Uniman Sand (#90) | 4 lb | 6.68% |
| Specialty Minerals #9 Limestone | 9 lb | 15.03% |
| Wacker RE 5028 N Latex Polymer | 1 lb | 1.67% |
| Uniman Sand (#60) | 4 lb | 6.68% |

The mixture is made using the techniques discussed above relative to Examples 1-3 and is used to manufacture any of the molded cementitious architectural products disclosed herein.

### Example 5

A wet cementitious mixture having a water to cement ratio of 0.35 is prepared for use in manufacturing molded cementitious architectural products by mixing together the following components in the stated amounts (% means weight percent unless otherwise specified):

| | | |
|---|---|---|
| Water | 10.5 lb | 13.04% |
| Methocel | 0.025 lb | 0.03% |
| French Cream #33 (66 g) | 0.15 lb | 0.18% |
| PVA Fiber (107 g) | 0.24 lb | 0.29% |
| Viscocrete 2100 (H₂O reducer, 272 g) | 0.6 lb | 0.74% |
| White Cement | 30 lb | 37.26% |
| Marble Mix | 21 lb | 26.08% |
| Uniman Sand (#90) | 4 lb | 4.97% |
| Specialty Minerals #9 Limestone | 9 lb | 11.18% |
| Wacker RE 5028 N Latex Polymer | 1 lb | 1.24% |
| Uniman Sand (#60) | 4 lb | 4.97% |

The mixture is made using the techniques discussed above relative to Examples 1-3 and is used to manufacture any of the molded cementitious architectural products disclosed herein.

### Example 6

A wet cementitious mixture having a water to cement ratio of 0.35 is prepared for use in manufacturing molded cementitious architectural products by mixing together the following components in the stated amounts (% means weight percent unless otherwise specified):

| | | |
|---|---|---|
| Water | 14 lb | 14.85% |
| Methocel | 0.027 lb | 0.03% |
| French Cream #33 (66 g) | 0.15 lb | 0.15% |
| PVA Fiber (127 g) | 0.28 lb | 0.30% |
| Viscocrete 2100 (H₂O reducer, 362 g) | 0.8 lb | 0.85% |
| White Cement | 40 lb | 42.44% |
| Marble Mix | 21 lb | 22.28% |
| Uniman Sand (#90) | 4 lb | 4.24% |
| Specialty Minerals #9 Limestone | 9 lb | 9.55% |
| Wacker RE 5028 N Latex Polymer | 1 lb | 1.06% |
| Uniman Sand (#60) | 4 lb | 4.24% |

The mixture is made using the techniques discussed above relative to Examples 1-3 and is used to manufacture any of the molded cementitious architectural products disclosed herein.

### Example 7

A wet cementitious mixture having a water to cement ratio of 0.35 is prepared for use in manufacturing molded cementitious architectural products by mixing together the following components in the stated amounts (% means weight percent unless otherwise specified):

| | | |
|---|---|---|
| Water | 17.5 lb | 16.20% |
| Methocel | 0.03 lb | 0.03% |
| French Cream #33 (66 g) | 0.15 lb | 0.13% |
| PVA Fiber (148 g) | 0.33 lb | 0.30% |
| Viscocrete 2100 (H₂O reducer, 454 g) | 1 lb | 0.93% |
| White Cement | 50 lb | 46.30% |
| Marble Mix | 21 lb | 19.44% |
| Uniman Sand (#90) | 4 lb | 3.70% |
| Specialty Minerals #9 Limestone | 9 lb | 8.33% |
| Wacker RE 5028 N Latex Polymer | 1 lb | 0.93% |
| Uniman Sand (#60) | 4 lb | 3.70% |

The mixture is made using the techniques discussed above relative to Examples 1-3 and is used to manufacture any of the molded cementitious architectural products disclosed herein.

### Example 8

A wet cementitious mixture having a water to cement ratio of 0.40 is prepared for use in manufacturing molded cementitious architectural products by mixing together the following components in the stated amounts (% means weight percent unless otherwise specified):

| | | |
|---|---|---|
| Water | 6 lb | 9.89% |
| Methocel | 0.018 lb | 0.03% |
| French Cream #33 (66 g) | 0.15 lb | 0.24% |
| PVA Fiber (79 g) | 0.17 lb | 0.29% |
| Viscocrete 2100 (H₂O reducer, 136 g) | 0.3 lb | 0.49% |
| White Cement | 15 lb | 24.74% |
| Marble Mix | 21 lb | 34.63% |
| Uniman Sand (#90) | 4 lb | 6.60% |
| Specialty Minerals #9 Limestone | 9 lb | 14.84% |
| Wacker RE 5028 N Latex Polymer | 1 lb | 1.65% |
| Uniman Sand (#60) | 4 lb | 6.60% |

The mixture is made using the techniques discussed above relative to Examples 1-3 and is used to manufacture any of the molded cementitious architectural products disclosed herein.

### Example 9

A wet cementitious mixture having a water to cement ratio of 0.40 is prepared for use in manufacturing molded cementitious architectural products by mixing together the following components in the stated amounts (% means weight percent unless otherwise specified):

| | | |
|---|---|---|
| Water | 12 lb | 14.63% |
| Methocel | 0.023 lb | 0.03% |
| French Cream #33 (66 g) | 0.15 lb | 0.18% |
| PVA Fiber (111 g) | 0.24 lb | 0.30% |
| Viscocrete 2100 (H₂O reducer, 272 g) | 0.6 lb | 0.73% |
| White Cement | 30 lb | 36.58% |
| Marble Mix | 21 lb | 25.61% |
| Uniman Sand (#90) | 4 lb | 4.88% |
| Specialty Minerals #9 Limestone | 9 lb | 10.97% |
| Wacker RE 5028 N Latex Polymer | 1 lb | 1.22% |
| Uniman Sand (#60) | 4 lb | 4.88% |

The mixture is made using the techniques discussed above relative to Examples 1-3 and is used to manufacture any of the molded cementitious architectural products disclosed herein.

### Example 10

A wet cementitious mixture having a water to cement ratio of 0.40 is prepared for use in manufacturing molded cementitious architectural products by mixing together the following components in the stated amounts (% means weight percent unless otherwise specified):

| | | |
|---|---|---|
| Water | 16 lb | 16.62% |
| Methocel | 0.027 lb | 0.03% |
| French Cream #33 (66 g) | 0.15 lb | 0.15% |
| PVA Fiber (133 g) | 0.29 lb | 0.30% |
| Viscocrete 2100 (H₂O reducer, 363 g) | 0.8 lb | 0.83% |
| White Cement | 40 lb | 41.55% |
| Marble Mix | 21 lb | 21.81% |
| Uniman Sand (#90) | 4 lb | 4.16% |
| Specialty Minerals #9 Limestone | 9 lb | 9.35% |
| Wacker RE 5028 N Latex Polymer | 1 lb | 1.04% |
| Uniman Sand (#60) | 4 lb | 4.16% |

The mixture is made using the techniques discussed above relative to Examples 1-3 and is used to manufacture any of the molded cementitious architectural products disclosed herein.

### Example 11

A wet cementitious mixture having a water to cement ratio of 0.45 is prepared for use in manufacturing molded cementitious architectural products by mixing together the following components in the stated amounts (% means weight percent unless otherwise specified):

| | | |
|---|---|---|
| Water | 6.75 lb | 10.99% |
| Methocel | 0.018 lb | 0.03% |
| French Cream #33 (66 g) | 0.15 lb | 0.24% |
| PVA Fiber (81 g) | 0.18 lb | 0.29% |
| Viscocrete 2100 (H₂O reducer, 136 g) | 0.3 lb | 0.49% |
| White Cement | 15 lb | 24.43% |
| Marble Mix | 21 lb | 34.21% |
| Uniman Sand (#90) | 4 lb | 6.52% |
| Specialty Minerals #9 Limestone | 9 lb | 14.66% |
| Wacker RE 5028 N Latex Polymer | 1 lb | 1.63% |
| Uniman Sand (#60) | 4 lb | 6.52% |

The mixture is made using the techniques discussed above relative to Examples 1-3 and is used to manufacture any of the molded cementitious architectural products disclosed herein.

### Example 12

A wet cementitious mixture having a water to cement ratio of 0.45 is prepared for use in manufacturing molded cementitious architectural products by mixing together the following components in the stated amounts (% means weight percent unless otherwise specified):

| | | |
|---|---|---|
| Water | 13.5 lb | 16.16% |
| Methocel | 0.023 lb | 0.03% |
| French Cream #33 (66 g) | 0.15 lb | 0.17% |
| PVA Fiber (116 g) | 0.26 lb | 0.31% |
| Viscocrete 2100 (H₂O reducer, 272 g) | 0.6 lb | 0.72% |
| White Cement | 30 lb | 35.92% |
| Marble Mix | 21 lb | 25.14% |
| Uniman Sand (#90) | 4 lb | 4.79% |
| Specialty Minerals #9 Limestone | 9 lb | 10.78% |
| Wacker RE 5028 N Latex Polymer | 1 lb | 1.20% |
| Uniman Sand (#60) | 4 lb | 4.79% |

The mixture is made using the techniques discussed above relative to Examples 1-3 and is used to manufacture any of the molded cementitious architectural products disclosed herein.

### Example 13

A wet cementitious mixture having a water to cement ratio of 0.45 is prepared for use in manufacturing molded cementitious architectural products by mixing together the following components in the stated amounts (% means weight percent unless otherwise specified):

| | | |
|---|---|---|
| Water | 18 lb | 18.32% |
| Methocel | 0.027 lb | 0.03% |
| French Cream #33 (66 g) | 0.15 lb | 0.15% |
| PVA Fiber (139 g) | 0.31 lb | 0.31% |
| Viscocrete 2100 (H₂O reducer, 363 g) | 0.8 lb | 0.81% |
| White Cement | 40 lb | 40.70% |
| Marble Mix | 21 lb | 21.37% |
| Uniman Sand (#90) | 4 lb | 4.07% |
| Specialty Minerals #9 Limestone | 9 lb | 9.16% |
| Wacker RE 5028 N Latex Polymer | 1 lb | 1.02% |
| Uniman Sand (#60) | 4 lb | 4.07% |

The mixture is made using the techniques discussed above relative to Examples 1-3 and is used to manufacture any of the molded cementitious architectural products disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of manufacturing a molded cementitious architectural product having a polished surface, comprising:
providing a wet cementitious composition comprised of water and hydraulic cement;
introducing the wet cementitious composition into a mold cavity;
allowing the hydraulic cement of the wet cementitious composition to partially hydrate beyond initial set to form a green cementitious body;
exposing a surface of the green cementitious body before the hydraulic cement reaches final hardening; and
burnishing at least a portion of the exposed surface of the green cementitious body before the hydraulic cement reaches final hardening in order to align hydraulic cement particles at the exposed surface and seal the exposed surface.

2. A method as recited in claim 1, the wet cementitious composition further comprising at least one polymer binder that assists in sealing the exposed surface.

3. A method as recited in claim 2, the polymer binder comprising at least one member selected from the group consisting of latex polymers, cellulosic ethers, starches, proteins, acrylic polymers, polysaccharide gums, rosins, and polymer resins.

4. A method as recited in claim 1, the wet cementitious composition further comprising at least one aggregate.

5. A method as recited in claim 4, wherein aggregate comprises platelet shaped particles that further assist in burnishing the surface of the cementitious body.

6. A method as recited in claim 1, the wet cementitious composition further comprising at least one type of fibers substantially homogeneously dispersed throughout the cementitious composition.

7. A method as recited in claim 6, the fibers comprising PVA fibers in an amount in a range of about 0.001% to about 4% by volume of the wet cementitious composition.

8. A method as recited in claim 1, further comprising positioning at least two separate mold parts in a desired orientation to yield the mold cavity into which the wet cementitious composition is introduced.

9. A method as recited in claim 8, at least one of the mold parts comprising a polymeric foam core that remains permanently attached to a cementitious shell to form the molded cementitious architectural product.

10. A method as recited in claim 9, at least one of the mold parts comprising a backer that is positioned next to the polymeric foam core in a manner so that, after removing the backer, the molded cementitious architectural product includes a mounting surface comprised of an exposed surface of the polymeric foam core and a portion of the cementitious shell adjacent to the exposed surface of the polymeric foam core.

11. A method as recited in claim 8, at least one of the mold parts comprising a front pattern having a surface configuration that at least partially corresponds to a desired shape of the exposed surface of the molded cementitious architectural product.

12. A method as recited in claim 8, wherein exposing a surface of the green cementitious body comprises removing at least one of the mold parts.

13. A method as recited in claim 1, wherein the exposing step is performed after the hydraulic cement has been allowed to partially hydrate more than halfway between initial set and final hardening as a function of hydration temperature.

14. A method as recited in claim 1, wherein the exposing step is performed after the hydraulic cement has been allowed to partially hydrate more than two-thirds of the way between initial set and final hardening as a function of hydration temperature.

15. A method as recited in claim 1, wherein the exposing step is performed after the hydraulic cement has been allowed to partially hydrate more than three-fourths of the way between initial set and final hardening as a function of hydration temperature.

16. A method as recited in claim 1, further comprising cooling the cementitious material after the hydraulic cement is partially hydrated beyond initial set and after exposing a surface of the green cementitious body in order to delay final hardening and increase a window of time within which burnishing may be carried out prior to the hydraulic cement reaching final hardening.

17. A method as recited in claim 16, wherein cooling is performed by immersing the green cementitious body in water.

18. A method as recited in claim 16, wherein cooling increases the window of time to at least 2 hours.

19. A method as recited in claim 16, wherein cooling increases the window of time to at least 6 hours.

20. A method as recited in claim 16, wherein cooling increases the window of time to at least 12 hours.

21. A method as recited in claim 16, wherein the cementitious material is cooled to a temperature less than about 20° C.

22. A method as recited in claim 16, wherein the cementitious material is cooled to a temperature less than about 10° C.

23. A method as recited in claim 1, wherein burnishing is carried out using a rotating polishing/burnishing wheel.

24. A method as recited in claim 23, the polishing/burnishing wheel comprising aluminum oxide.

25. A method as recited in claim 1, further comprising allowing the hydraulic cement to hydrate beyond final hardening in order for the green cementitious material to harden and form at least a portion of the molded cementitious architectural product.

26. A method as recited in claim 25, further comprising machining a portion of the molded cementitious architectural product after hardening of the cementitious material to yield a desired shape.

27. A method of manufacturing a molded cementitious architectural product having a polished surface, comprising:
providing a wet cementitious composition comprised of water, hydraulic cement, and at least one polymeric binder selected from the group comprising acrylic polymers, latex polymers, cellulosic ethers, starches, polysaccharide gums, rosins, and polymer resins;
introducing the wet cementitious composition into a mold cavity;
allowing the hydraulic cement of the wet cementitious composition to partially hydrate beyond initial set to form a green cementitious body;
exposing a surface of the green cementitious body before the hydraulic cement reaches final hardening; and
burnishing at least a portion of the exposed surface of the green cementitious body before the hydraulic cement reaches final hardening in order to align hydraulic cement particles at the exposed surface and seal the exposed surface.

28. A method as recited in claim 27, further comprising allowing the burnished cementitious body to hydrate to beyond final hardening, the molded cementitious architectural product consisting essentially of the burnished cementitious body with no additional structures attached thereto.

29. A method as recited in claim 27, the mold cavity being partially defined by a lightweight foam core that remains attached to the burnished cementitious body, the the molded cementitious architectural product being comprised of the burnished cementitious body and the attached lightweight foam core.

30. A method of manufacturing a molded lightweight cementitious architectural product having a polished surface, comprising:
forming a mold cavity by positioning a front pattern having a desired surface configuration for the architectural cast stone product and a foam core in a spaced apart orientation so as to have a space therebetween that at least partially defines the mold cavity;
introducing a wet cementitious composition into the mold cavity and into contact with the foam core, the cementitious composition being comprised of water and hydraulic cement;
allowing the hydraulic cement of the wet cementitious composition to partially hydrate beyond initial set to form a green cementitious shell that at least partially surrounds the foam core;
removing the front pattern from the green cementitious shell before the hydraulic cement reaches final hardening to yield an exposed surface of the green cementitious shell and so that the foam core and green cementitious shell remain attached together; and
burnishing at least a portion of the exposed surface of the green cementitious body before the hydraulic cement reaches final hardening in order to align hydraulic cement particles at the exposed surface and seal the exposed surface.

31. A method as recited in claim 30, the wet cementitious composition further comprising at least one polymeric binder that assists in aligning the hydraulic cement particles in the exposed surface and/or sealing the exposed surface.

32. A method as recited in claim 31, the polymer binder comprising at least one member selected from the group consisting of acrylic polymers and latex polymers.

33. A method as recited in claim 30, further comprising attaching the front pattern and foam core to a backer, the backer maintaining the front pattern and foam core in the spaced apart orientation, the front pattern, foam core and backer at least partially defining the mold cavity.

34. A molded cementitious architectural product manufactured according to the process of any of claims 1, 27 or 30.

35. A molded cementitious architectural product, comprising:
a molded cementitious body formed by allowing a wet cementitious composition comprised of hydraulic cement, water and at least one polymer binder selected from the group comprising acrylic polymers and latex polymers to harden by hydration of the hydraulic cement; and
a polished surface of the cementitious body formed by burnishing an exposed surface of the cementitious composition while in a green condition after the hydraulic cement reached initial set but before reaching final hardening in order to align hydraulic cement particles and seal the exposed surface of the cementitious body.

36. A molded cementitious architectural product as recited in claim 35, further comprising a lightweight foam core, wherein the molded cementitious body comprises a cementitious shell that at least partially surrounds the lightweight foam core.

37. A molded cementitious architectural product as recited in claim 36, further comprising a mounting surface comprised of an exposed surface of the lightweight foam core and an end surface of the cementitious shell adjacent to the exposed surface of the lightweight foam core.

38. A molded cementitious architectural product as recited in claim 37, the exposed surface of the foam core being substantially flush with the end surface of the cementitious shell.

39. A molded cementitious architectural product as recited in claim 36, wherein the foam core is comprised of expanded polystyrene.

40. A molded cementitious architectural product as recited in claim 36, wherein the cementitious shell has a thickness in a range from about ¼ inch to about 1 inch.

41. A molded cementitious architectural product as recited in claim 35, wherein the polished surface has a non-planar surface configuration with three-dimensional features.
